(19) United States
(12) Patent Application Publication
(10) Pub. No.: US 2004/0039920 A1
(43) Pub. Date: Feb. 26, 2004

(54) Security cabinet system for controlling with user's id data

(76) Inventors: Jong-Hae Kim, Socho-Ko (KR); Ji-Tae Kim, Glendale, CA (US)

Correspondence Address: Erik M Arnhem, Second Floor, 4250 Wilshire Boulevard, Los Angeles, CA, 90010, US

(21) Appl. No.: 10/381,965

(22) PCT Filed: Oct. 5, 2001
(86) PCT No.: PCT/KR01/01660

(30) Foreign Application Priority Data
Oct. 5, 2000 (KR) 2000/27813 U

(51) Int. Cl. H04L 9/00

(52) U.S. Cl. 713/185

(57) ABSTRACT

The present invention is related to a security cabinet system for storing the main body of the PC, having 3-ways PC control system for entering users ID data with a keypad system on the container, in order to prevent any unauthorized access to the PC for transmitting or duplicating data, or disassembling PC to separate HDD data storage device, and having a means to control the ambient temperature in the PC container. This system perfectly protects the PC against any unauthorized access to operate the PC with various software means as well as attempts with hardware means to separate the HDD from the PC by any unauthorized persons together, and provides the user with the simplest solution to control the PC without opening the cabinet by using users ID data which users are always carrying with them by a form of a bank's card, a drive license, a fingerprint or a password.

### FIELD OF THE INVENTION

The present invention relates to a system apparatus of the security container for storing the main body of the PC and the data recording medium, having a means to control the ambient temperature and a means to control PC in 3-way from the outside of the container by entering user's ID data utilizing a keypad and user's ID data which users always carrying with them, in order to prevent any unauthorized access to the PC for transmitting or duplicating data, or disassembling PC to separate HDD data storage device.

In addition, this invention provides a security system for a filing cabinet or office furniture for locking and unlocking with user's ID data to replace the conventional key and tracing the unauthorized user's ID and operation time without instaling a costly PC network.

### DESCRIPTION OF THE RELATED ART

The critical security weak-point of any office PC is that the HDD data storage device can be so easily separated within a few seconds. This can compromise all of the confidential data in the PC regardless of all the expensive security software means users have installed. Moreover, all of the PCs in the office are very vulnerable to unauthorized persons to accessing to transmit or duplicate data, since all of the PCs are left alone on the desks, especially after-hours at night.

In order to prevent such cases, there were some cabinets or safes for the PCs but there were some physical inconveniences of opening the safe or the cabinet whenever users operate PCs.

Also, it does not prohibit from the multiple users to operate PC and does not leave any records of the user's ID. In order to prevent this problem the users of the PC need to installed the expensive network system but it does not help any physical theft and sometimes it leaves damages to software.

In addition, the locking system of the ordinary cabinet or office furniture has problems with stolen, lost, or duplicating keys to the locks. Especially, in public offices, if someone get out a classified document and return it after duplicating, no body knows the exposure of document. To solve these kinds of problems, carrying special designed card keys also created the same burden of carrying the extra card keys and need to install the costly PC network.

### SUMMERY OF THE INVENTION

A primary object of the present invention is to overcome the security weak points of the ordinary cabinet for PC or documents. By using user's own identification card such as driver's license, bank's ATM card or personal password for accessing PC or locking/unlocking the cabinet without installing a costly PC network, the security problems can simply be solved without worrying the theft of hard disk device, copying or duplicating the information.

The present invention provides the simplest and easiest way to access the user's PC. Users can operate the PC with a monitor and a keyboard on their desk, without opening the cabinet, simply by sliding their personal bank card or by entering their passwords on the keyset of the cabinet door. Nobody can access the PC or open the PC cabinet without verifying the user's ID with a bank card or a password.

This invention provides the highest level of security for the PC, since it perfectly protects the PC against and unauthorized access to operate the PC with various with hardware means to separate the HDD data storage device from the PC by any unauthorized persons.

Also, as using this security system in cabinet when opening the cabinet, it memorizes the ID of the each user and the operation time for tracing the security violations without using high priced networking system.

According to the preferred embodiment of the invention, the lockable door detects the identification of intruder by memorizing the code data of user's card, which generating the PC operation data or the opening data of the lockable door, in the memory means consecutively by code numbers of user's ID.

Further more, by using one's personal cards to access without carrying any special keys or cards, it provides more security by using user's personal bank card and free from burden of carrying special keys or card key.

Authorized users use their own personal credit card to operate PC or open the cabinet. There is no key to carry or lose. Nor are there any complicated dial combination numbers to forget or disclose.

According to a preferred embodiment of the invention, the code for operating PC and activating the electronic locking and unlocking mechanism, which is entering by the external keypad means is unlimited until the user activate the external menu selection means for added security.

Other object of the invention is to provide a multi-way locking and unlocking system through using ID data of user's bank card and passwords to make most convenient way of accessing with the 3-way locking system created by user's choice for added security and maximum convenience.

Another aspect of the present invention is that ambient temperature in the PC cabinet is automatically controlled by it's built-in thermostat fan system suited in the PC cabinet.

Other advantages and characteristics of the present invention will become clear from the following detailed description of a preferred embodiment in conjunction with the accompanying drawings.

### BRIEF DESCRIPTION OF THE DRAWINGS

The figures in the drawing are briefly described as follows:

FIG. 1 is a block diagram of the security system of the present invention.

FIG. 2 is a block diagram of the file cabinet.

FIG. 3 is a detailed view of FIG. 2 when its normal locked and unlocked position.

FIG. 4 is a modified illustrated view of FIG. 3 locking and unlocking system.

FIG. 5 is another modified illustrated version of FIG. 3.

### DETAILED DESCRIPTION OF THE INVENTION

To overcome the limitations in the prior art described above and to overcome the limitations that will become apparent upon reading and understanding the present specification. The system in accordance with the principles of the present invention provides the technologies for accessing PC without opening the cabinet, locking and unlocking with user's ID data to replace any special keys or cards to operate using 3-way locking and unlocking system without using expensive PC networking system to memorize user's ID and time data to perform security for the PC cabinet and the filing cabinet.

As described so far, this invention provides more added security and convenience to the user than that of the prior arts. It is understood that many modifications and variations can be made therein, without departing from the spirit of the invention and from the scope of the appended claims.

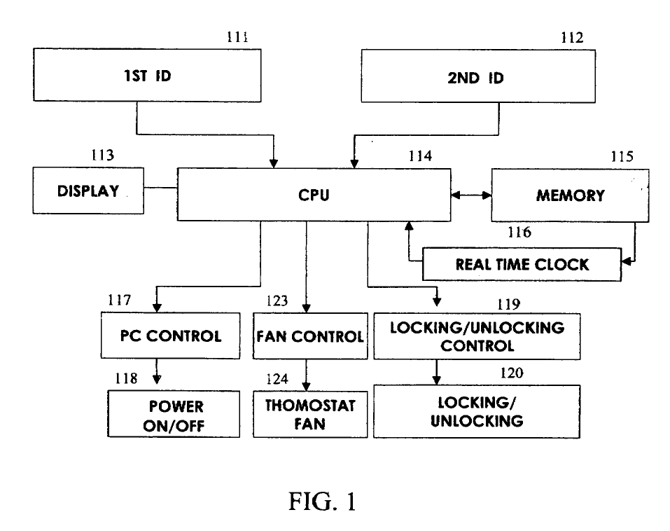

In the following description of the exemplary embodiment, reference is made to the accompanying drawings which form a rest there of and in which is shown by way of illustration the specific embodiment in which the invention may be practiced. It is be made without departing from the scope of the present invention. FIG. 1 illustrates the block diagram of a system for PC security utilizing with user's ID data according to the present invention.

According to the illustration of FIG. 1, the invention comprises the first digital data input means(111) for controlling CPU of the system; the second digital data input means (112) for controlling CPU of the system in addition to the first digital data input means; a memory means (115) coupled to CPU for memorizing the digital data which the first digital data input means and the second digital data input means inputted; a control means(119) coupled to CPU for controlling the operation of the locking/unlocking apparatus of the cabinet according to the control data signal from CPU of the system; a real time clock(116) for designating the time of each operation for memory means according to the control signal from CPU of the system; a PC control means(117) for controlling power on/off apparatus(118) of the PC according to the control signal from CPU of the system; a display means(113) for displaying the status of the system; and CPU(114) for controlling the above means of the system.

The first digital data input means(111) comprises at least one or more of a magnetic card reader, a IC card reader, a RF card reader, a living bionics instrument of user, or a mobile phone receiver. The second digital data input means(112) comprises at least one or more of a keypad system for number, letter or symbols.

The data entry device(111,112) by user's choice can be designed in many ways according to the system designer by using a card reader, a finger print scanner, a video image scanner, a voice scanner, an iris of eye scanner, a venous scanner and a keypad system of number or letters.

With the above configuration of the system, users of the PC stores the main body of user's PC in the cabinet, and connects wires between PC control means (117) of the system coupled to the CPU(114) and PC's power on/off switcher (118).

If the ambient temperature in the PC cabinet is controlled by the CPU, the ventilation control means should be connected with the PC control means(117) to operate the ventilation fan on whenever PC is on.

If the ambient temperature is automatically controlled by the built-in thermostat fan system suited in the cabinet, it need not to be connected with the PC control means.

First of all, user select one of the user's ID data according to the system configuration of the digital data input means(111,112), and insert user's ID through the 1st digital data input means(111) and the 2nd digital data input means(112), for the registration of ID which to be used as a key of the system.

If the system is equipped with a magnetic card reader as the 1st digital input mans(111) and a keypad as the 2nd digital input means(112), and users register their ID data through the first digital data input means(111)with their own personal card such as a bank's credit card or a club membership card which users are always carrying with them and want to use as a key, and their passwords through the second digital data input means(112), then CPU(113) receives the ID data signal from the 1st digital data input means(111) and the 2nd digital input means(112) and memorize the digital data signals to the memory means(115). After the registering of user's digital data when users input their digital data through the digital data input means (111, 112), the CPU (114) receives the data from user and compares the data whether the read data are the same as data stored in the memory means (115), if the data matches, the CPU (114) orders the PC control means (117) to activate the power on/off switcher (118) as programmed.

However, the read data are not same as the data stored in the memory means (115), the CPU shows an error in the display means (113) and remains silent.

According to the pre-programmed protocol of the CPU (114), there are several different ways to control the system in accordant with the digital data read.

For example, if users stored their card only with the first digital data input means (111), users can control the system with card only, if users stored their password only, with the second digital data input means (112), users can control the system with password only and users stored their digital data both of the first and the second digital data input means (111,112) together, the users only can control the system with two kinds of data together which users registered through the 1st digital data input means and the 2nd digital data input means.

In this system therefore, users can control the system in 3-ways according to the user's choice and this system provides the enhanced security since the intruder does not know that the authorized users stored their data in which way among 3-ways.

Another aspect of this system is that users can control the locking/unlocking apparatus of cabinet in multi-way for the operation of PC and the locking/unlocking operation of the container by their digital data input means(111,112)and their digital data stored in the memory means (115). Users are memorizing their own ID data through one or both of the first digital data input means and the second digital data input means with their own personal card which representing user's ID, such as a bank's credit card, a club membership card, a driver license, ID card, a password comprising numbers, letters or symbols according to the preprogrammed protocol of the CPU (114) to operate the system.

When users want to operate the PC at the beginning, users select their own personal identification data according to the system of the first digital data input means (111)and the second digital data input means(112), and activates PC operation button on the keypad of the ID data input means, then, the CPU checks the data and activates the PC control means (117) to make the power on of the PC and the display means (113) shows the status of PC on.

When users trying to open the cabinet, users need to input ID data as described before and activate the locking/unlocking button on the keypad of ID data input means(112).

When the data from both data input means matches, the locking/unlocking control means (119) controls the locking and unlocking apparatus (120) to open the system, and at the same time, recognizes the opening time as in data through real time clock (116), puts the data into memory device (115) and displays open status through the display means (113).

If the user decides to use same ID data over again without inputting ID data manually, user can input user's ID data into memory device (115) and put the locking system into automatic locking when closing and then, user only needs to input ID data only for unlocking.

Moreover, this system could be used in multiple user's with one ID data input mean, by the way that multiple users input different ID data to memory device (115) to operate the locking mechanism. In this case, the CPU (114) transfers different ID data to memory device (115) and when all the ID data matches, it will unlock.

Furthermore, in the present invention, when using two or more card readers with multiple card data could be stored in the memory means(115) and when multiple card data matches, CPU (114) will make the controller means(119) for locking and unlocking mean (120) to operate for more security purpose.

Above mechanism can be used in situation when very high security is needed such as two or more users attend and when both ID matches, it will operate.

As described so far, user can control PC in the cabinet by inputting control data from the outside of cabinet by connecting wires, between PC's power on/off switch means(118),and PC control means (117)of the CPU (114).

As described before user can input the ID data or password in memory device (115) through the data entry devices (111,112) and dispatch with a code for PC control such as “#” button on the keypad to CPU (114), CPU will compare the data from memory means and ID data or password matches, it will control the power controlling switch (117) on the PC. Therefor user will be able to use PC without opening the cabinet.

Further more, the system in the security container is not only limited to one PC for one container, it is possible for multiple users with multiple PCs for one container and users use their own separate ID data to control their own PC.

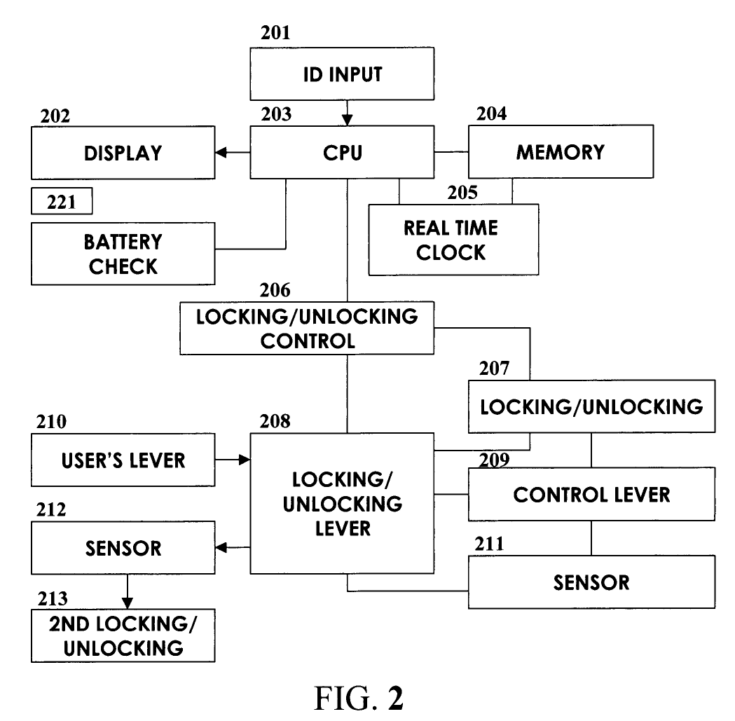

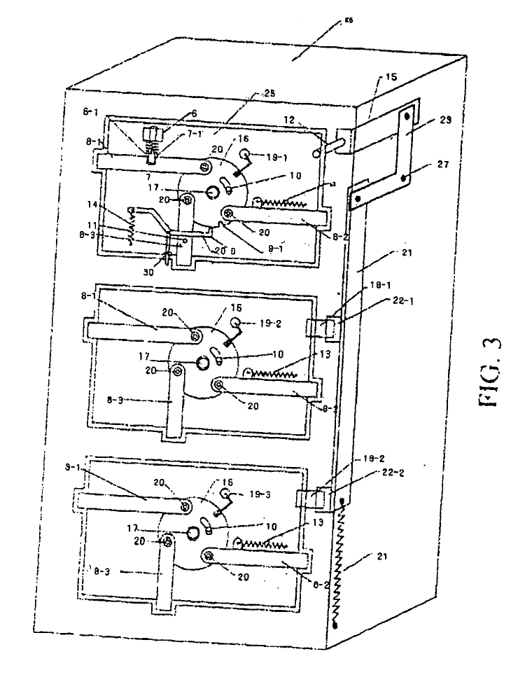

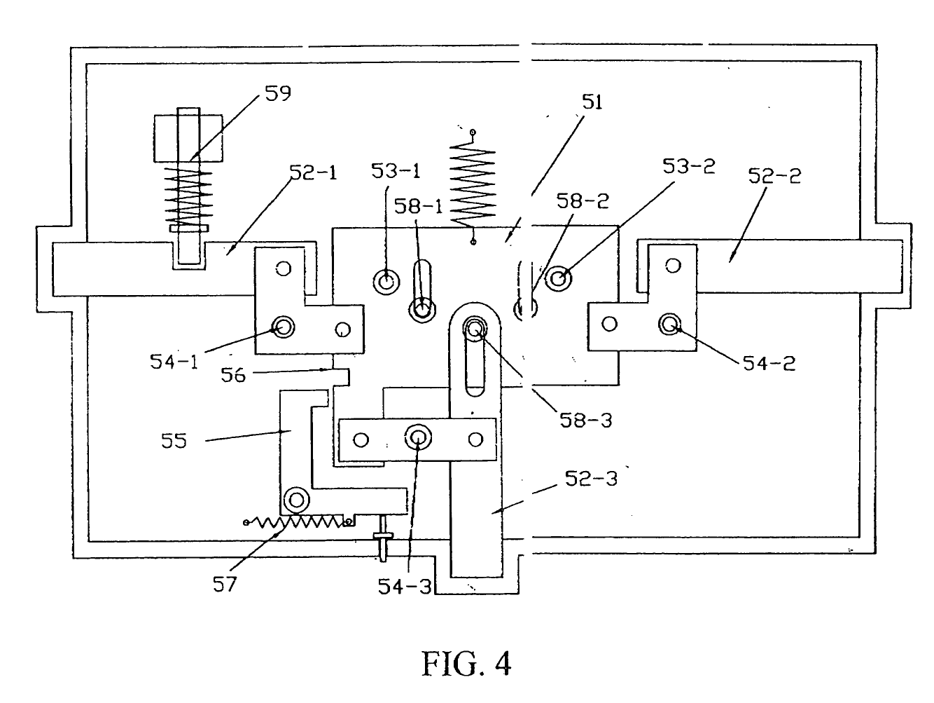

FIG. 2 is the block diagram of the filing cabinet system using the present invention and FIG. 3 and FIG. 4 are the schematic drawing of the locking/unlocking device to reach the goal of the invention.

According to FIG. 2, FIG. 3, and FIG. 4, the filing cabinet system of the present invention is comprising a user ID data input means(201); a real time clock (205) to measure activation time and date; a memory device (204) to store the ID data and time/date; a display means (202) to display status of lock/unlock and battery life; a locking/unlocking device (206) to control the security container, a battery checking means (221) to check and measure the battery life; a CPU (203) to control all of the means in the system.

In order to achieve security container's locking/unlocking system in a solenoid means, two or more of locking lever (8-1, 8-2, 8-3) between door panel of cabinet and side panel to perform locking/unlocking; a locking device (7) to control locking lever, a solenoid mean (6) to control locking device; a user's lever (10) from outer side of the container, a locking lever controller (9) for when locking lever is opened (before closing), in order to stop solenoid mean to lock automatically; a sensor (11) to detect control locking lever controller when the doors are locked; a locking sensor (12) to sense and control 2nd door when the 1 st one closes.

According to a preferred embodiment of the invention, the user's ID data input means can be comprised with a single ID data input device or with multiple ID data input devices as of the embodiment (111,112) described on FIG. 1.

When the user inputs the ID data, then the CPU (203) stores an entering codes in the memory device (204). When multiple users are sharing one container, input multiple ID data to be stored in the memory means(204) and locking/unlocking operation are the same as described on FIG. 1.

Before using the cabinet, user stores the ID data in advance as described. When opening the cabinet, the user inputs user's ID data then the CPU (203) checks whether the read data from data input device (201) are same as those stored in the memory means(204). If data match, the CPU activates locking/unlocking control means(206) to control the locking/unlocking lever(208) to open by controlling, solenoid bar(6-1) goes up position and deactivates the locking/unlocking lever (8-1).

At the same time, the CPU (203) stores the data of the time/ date of the real time clock (205) and user's ID to the memory device(204) and displays the open status on the display means(202).

At the memory device, the data is stored in order by time and date and depends on the capacity of the memory, the memory device stores the most recent data of opening, and it will automatically erase the oldest data memory and keeps the certain amount of data.

When the solenoid system is on, the solenoid bar goes up position and user can control the locking/unlocking lever (8-1). The user uses user's lever(10) to rotate the rotating disk (16) of the locking/unlocking system then, locking/unlocking lever (8-1,8-2,8-3) shifts to inside of the cabinet to separate cabinet's drawer from the cabinet itself.

When user opens the drawer, rotating disk (16) controls locking/unlocking lever (8-1, 8-2, 8-3) to move cabinet's drawer from the main frame in certain distance.

But when drawer is open and user let go of user's lever (10), power by spring (13), locking/unlocking lever (8-1, 8-2, 8-3) shuts down because of locking/unlocking hole (9-1) and locking lever controller.

At this moment, power by control spring (14) locking lever controller is captured by locking/unlocking hole (9-1)'s rotating disk (16), even user is away from user's lever (10) and spring (14) is always pushing locking/unlocking lever (8-1, 8-2, 8-3) close to outside, it does not exceed the limit.

At the same time, even solenoid's electric current is off, the solenoid bar (6) and locking/unlocking lever (8-1) stays upper position and does not lock to the locking hole (6-1).

When closing cabinet's drawer, locking/unlocking lever (30) moves upward by cabinet's frame and locking lever controller (9) separates from locking/unlocking hole (9-1), and power by spring (13) locking/unlocking lever (8-1, 8-2, 8-3) moves towards outside, then solenoid's locking hole (6-1) located in locking/unlocking lever (8-1) moves down, solenoid (6) bar moves down force by spring located inside of solenoid then locks into the locking hole (6-1) and shuts down the movement of locking/unlocking lever.

When cabinet's drawer is closed according to movement explained above, locking/unlocking sensor (12) located exterior of 1st base drawer of cabinet pushes other drawer's 2nd locking/unlocking mean (15) and enforced by axis of rotation (23), cabinet's other drawer's locking/unlocking control lever (21) moves upward, then control pin (18-1, 18-2) located exterior of cabinet drawer and all other cabinet's drawer is locked by locking/unlocking wing (22-1, 22-2) located at locking/unlocking control lever(24).

Configuration of locking/unlocking sensor (12) located exterior of 1st base drawer of the cabinet controls when cabinet drawer closes affects rest of cabinet drawers to lock at the same time can be modify upon designers request therefore mechanism for this portion invokes from existing cabinet's locking/unlocking mechanism.

As it explained above, when opening the cabinet's drawer with ID input means, drawer's locking/unlocking control lever (24) which is stopping other drawer's locking/unlocking wing (22-1, 22-2) moves by force by spring (21) then user can open each drawer separately. In addition, when ordinary key equipment (19-1, 19-2, 19-3) is installed for addition, user can control cabinet drawer opening by ID input mean and key for dual safety for more security.

In addition, sensor and alarm system can be added to CPU (203) to control and detect any unwanted force towards security container to alert and more security purpose.

For example, when heat sensor is installed, sensor can detect any harm from a welding machine and turns on the alarm. When shock sensor is installed, sensor can detect any movement. Also, above explained mechanism can be installed at multi drawer cabinet, large size security door or any entrance door for bank, military security purpose, and any built in fixture with more than one opening. Further more, instead of solenoid mean for locking system, small size motor can be install for same purpose.

Further, according to FIG. 3 instead of a rotating disk (16), board (51) which moves up and down can be install as FIG. 4 to force outer user's lever axis (53-1, 53-2) to move board (51) which moves upward and downward center by fixed axis (58-1, 58-2, 58-3), because of board's movement, control lever (52-1, 52-2, 52-3) moves center by control axis (54-1, 54-2, 54-3), when lever (53-1, 53-2) goes upward control lever gathers inward to open, at this time locking/unlocking axis (55) moves towards locking/unlocking home (56) force by spring (56), then drawer can be open and have same affects as rotating disk (16).

Also, using battery to initiate power, the battery checking circuit is on only when user inputs user's ID data to turn ON the system and this battery checking method can save great deal of wasting battery length compare to ordinary system which the battery checking circuit is always on to check the battery power.

What is claimed is:

1. A security container system for the PC comprising a container for storing the main body of the PC; a lockable door; a temperature control means for ventilating heat from the PC, and a means for controlling the system;
said means for controlling the system comprising, (1)at least one or more of user's ID data input means for inputting user's identification data; (2) a memory means for storing user's ID data coupled to CPU; (3) a locking and unlocking apparatus for the security container; (4) a locking and unlocking control means for controlling said locking and unlocking apparatus; (5) a display means for displaying the status of the system operation; (6) a PC control means coupled to the CPU for controlling power on/off of the PC; (7) a menu selection means coupled to the CPU for selecting the PC operation or the locking/unlocking operation; (8) a central processing unit (CPU) for controlling the system including the locking/unlocking operation and the PC operation of the security container, having code-comparing capability for delivering an operating signal to the locking and unlocking control means and the PC power control means of the container when the user-generated activation codes are the same as the stored code of the memory means;
said temperature control means comprising a ventilation fan suited in the container and a thermostat sensor for detecting the temperature in the container.

2. A security container system of claim 1, wherein the user's ID data input means comprising a card reader means such as a magnetic card reader, an IC card reader or RF card reader.

3. A security container system of claim 2, wherein the user's ID data input means further comprising a keypad means in addition to the card reader means and having 3-way control capability by a card, by a password and by a card with password.

4. A security container system of claim1, wherein the user's ID data input means comprises a scanner of living bionics instrument of user such as a finger print scanner, a video image scanner, a voice scanner, an iris of the eye or a venous scanner.

5. A security container system apparatus of claim 4, wherein the said user's ID data input means further comprising a keypad means in addition to the scanner of living bionics instrument of user having 3-way control capability by a scanner of living bionics instrument, by a keypad or by a scanner of living bionics instrument and a keypad.

6. A security container system of claim 1, the security container stores at least two or more unit of the main bodies of PCs and each PC is controlled with different ID data.

7. A security container system of claim1, further comprises a real time clock means for designating the activation time of PC on/off and/or the locking and unlocking of the lockable door of the container for memorizing in the memory means coupled to the CPU.

8. A security container system of claim1, wherein the ID data input means comprises a wireless communication apparatus such as a mobile telephone receiver, RF receiver or IF receiver.

9. A security container system of claim 8, further comprising a keypad means in addition to the wireless communication apparatus and having 3-way control capability by a wireless communication apparatus by a keypad, or by a wireless communication apparatus and a keypad together.

10. A security container system of claim 1, wherein the temperature control means comprising a ventilation fan and a wire connection with the PC power control means.

11. A security filing cabinet system for office comprising a filing cabinet having a plurality of lockable sliding drawers and a means for controlling the system;
each said sliding drawers of the filing cabinet comprising a locking and unlocking apparatus suited in side of the each drawer door;
a means for controlling the system comprising, (1) at least one or more of user's ID data input means for inputting user's identification data; (2) a memory means for storing user's ID data and the time of each locking and/or unlocking action coupled to the CPU; (3) a locking and unlocking control means for controlling the said locking and unlocking apparatus with an electronic signal; (4) a display means for displaying the status of the system operation; (5) a real time clock means for designating the time and the date of each locking and/or unlocking action by user's ID data coupled to the CPU; (6) a central processing unit(CPU) for controlling the said means and the operation of the system having code comparing capability.

12. A security cabinet system of claim 11, further comprising a battery checking circuit which activating only during the preprogrammed time period when user's ID data is inputted to save energy.

13. A security cabinet system of claim 11, further comprising a locking and unlocking control lever for controlling the locking and unlocking operation of all of the sliding chest drawers of the cabinet together by the closing force of the first sliding chest drawer.

14. A security cabinet system of claim 11, wherein the locking/unlocking apparatus inside of the lockable sliding drawer comprising,
(1) A rotating disk connected from the center by axis of rotation which is installed the inside of lockable chest drawer door having at least one or more of the locking and unlocking lever which moves up/down or left/right depending of movement of rotation disk and having to pop out when closing lockable door and automatically closes by doorsill;
(2) a solenoid means for blocking the passage of the locking and unlocking lever bar;
(3) a user's lever means to open the lockable sliding drawer, according to the signal from the CPU of the means for controlling the system to remove the solenoid bar of the said solenoid means from lock position for rotating disk to force to move the locking/unlocking lever inward to move door from the frame;
(4) a control lever mean for freezing the movement of rotating disk, having a spring to freeze locking lever in unlock position;
(5) a locking/unlocking means for locking and unlocking the movement of the said rotating disk by the controls of the solenoid bar.

15. A security cabinet system of claim 10, wherein the locking and unlocking apparatus inside of the lockable sliding drawer door, comprising,
(1) a board that moves up and down inside of a lockable chest door by user's lever control;
(2) A fixed axis installed right, left and bottom of board when board goes down locking/unlocking lever gathers inward;
(3) a spring system that forces board to move upward and controls locking/unlocking lever in lock position;
(4) a solenoid mean to control locking/unlocking lever by solenoid bar that moves horizontally and located upper part of locking/unlocking lever moves into the locking hole by spring system;
(5) a user's lever means to open the lockable drawer door according to the signal from the CPU of the means for controlling the system to move the solenoid bar upward removing from lock hole, by the user's action to move door from the frame;
(6) a control system that forces locking/unlocking lever to stop returning to locking position when user uses locking/unlocking lever to unlock;
(7) A locking/unlocking means for locking and unlocking the sliding drawer.

16. A security cabinet system of claim 11, wherein the filing cabinet is a desk cabinet, a safe or an office furniture having a lockable door instead of the filing cabinet.

17. A security cabinet system of claim 14 or 15, further comprising an electronic motor instead of a solenoid means to intercepts the hole of locking/unlocking lever by the electric motor's rotation power.

18. A security cabinet system apparatus of claim 11, wherein the user's ID data input means comprising a card reader means such as a magnetic card reader, an IC card reader or RF card reader.

19. A security cabinet system of claim 11, wherein the user's ID data input means comprises a scanner of living bionics instrument of user such as a finger print scanner, a video image scanner, a voice scanner, an iris of the eye or a venous scanner.

20. A security container system apparatus of claim 18 or 19, wherein the said user's ID data input means further comprising a keypad means in addition to the scanner of living bionics instrument or a card reader means, and having 3-way control capability by a card or a scanner of living bionics, by a password and by a password with a card or a scanner of living bionics.

21. A security cabinet system of claim 11, wherein the user's ID data input means comprises a wireless communication apparatus such as a mobile phone receiver, a RF receiver or an IF receiver.

22. A security cabinet system of claim 21, further comprising a keypad system in addition to a wireless communication apparatus, and having 3-way control capability by a wireless communication apparatus, by a keypad or by a wireless communication apparatus and a keypad.

23. A system of claim 1 or 11, wherein a means for controlling the system further comprising a means for overriding the locking/unlocking apparatus of the system with an external signal generated with an external control module.

24. A method for controlling PC stored in the security container with a keypad located outside of the container comprising the steps of,
(1) installing at least one or more of a mean for entering user's ID a memory mean for storing the user's ID data; an electronic locking/unlocking mean for the lockable door, a central processing unit to control the locking/unlocking, and controlling on/off switch of PC; a menu selection means of locking/unlocking of the lockable door or PC power on/off located outside of the lockable door;
(2) inputting ID data of user for verifying user's ID for controlling locking/unlocking or PC power on/off;
(3) selecting menu for delivering a signal for locking/unlocking code or a signal for PC power on/off coupled to a central processing unit;
(4) operating PC or opening the container as of the menu selected.

25. A method for saving energy for checking the remaining of battery power for the electronic locking/unlocking system powered by a battery comprising the step of,
(1) programming to activate the battery power checking circuit only when user turns on the system;
(2) checking the battery power during user turns on the system and displaying the status of battery power or warning only when the battery power is low;
(3) Cutting the power for checking the battery power after checking operation by a preprogrammed protocol of the system to save the energy.
